(19) United States
(12) Patent Application Publication
(10) Pub. No.: US 2005/0229513 A1
(43) Pub. Date: Oct. 20, 2005

(54) Accent frame

(76) Inventor: Wade C. Horton, Baltimore, MD (US)

Correspondence Address: Royal W. Craig;Law Offices of Royal W. Craig, Suite 153, 10 N. Calvert Street, Baltimore, MD, 21202, US

(21) Appl. No.: 10/825,836

(22) Filed: Apr. 17, 2004

(51) Int. Cl. E04B 1/00; E04B 5/00; E04B 7/00; F21V 15/00

(52) U.S. Cl. 52/280

(57) ABSTRACT

An accent frame for decorating and covering up the area of a ceiling, wall, or floor, surrounding a recessed article of a type having a finishing ring or covering plate. The accent frame is a rigid sheet of thin material that includes an aperture of a size and shape corresponding to the size and shape of the structure cutout. It further includes a decorative outer edge. The frame is easily installed by centering the frame aperture over the cut out and sandwiching the frame between the finishing ring or covering plate and the structure. Attaching the ring or covering plate to the recessed article secures the frame. The shape and coloration of the accent frame may suggest ornamental objects or geometric shapes to achieve a decorative effect.

### CROSS-REFERENCE TO RELATED APPLICATIONS

The present application derives priority from U.S. Provisional Patent Application No. 60/463,512 for “LIGHTING ACCENT RING”; Filed: Apr. 16, 2003.

### BACKGROUND OF THE INVENTION

1. Field of the Invention

The invention relates to an accent frame for use in conjunction with recessed fixtures, switch plates, electrical outlet plates, registers, grills, grates and the like, that serves to cover any imperfections in the finish or cut of the surrounding ceiling, wall or floor. The invention further relates to the ornamental design of such an accent frame.

2. Description of the Background

Recessed lighting is a popular feature of interior design. Numerous recessed lighting fixtures can be placed in a room to achieve full and balanced lighting without crowding the visual lines of the room and without detracting from other features, which may be obscured by numerous protruding lighting fixtures. Recessed lighting fixtures also allow for directional lighting to effectively focus the light on a particular area or object. These and other attributes make recessed lighting popular and the use of recessed lighting often calls for the installation of many fixtures in a single room.

In order to mount a recessed lighting fixture, an aperture or cutout is typically made into the ceiling or wall material (i.e., drywall, wood paneling, or acoustic ceiling tiles) for insertion of the recessed lighting fixture. The fixture is then mounted (ie. bracketed) to a structural feature in the ceiling or wall (ie. a joist, rafter, or stud). In the case of dry wall, the cutout is made and joint compound or spackling compound is spread around the edges of cutouts to cover the rough edges and fix any mistakes in the cut. Once the compound is dry, it is sanded to smooth and it is painted and/or textured to match the surrounding wall or ceiling to give a seamless appearance. In the case of drop ceiling tiles or wood paneling, mistakes or rough edges are not easily corrected.

Recessed lighting fixtures are often sold with a metal or plastic trim ring (also called a finishing ring) which is attached to the recessed portion of the lighting fixture and includes a flange which extends radially outward from the fixture. The purpose of the trim ring is to cover the joint between the lighting fixture and the wall or ceiling, hiding any imperfections in the cutout. This eliminates the need for the time consuming process of perfectly cutting and/or carefully finishing the edge of the wall or ceiling cutout. However, many times the imperfections in the cutout are so severe that the standard trim ring often does not cover them up.

The use of a trim ring has its obvious advantages, especially when numerous lighting fixtures are installed in a single room. However, more often than not the trim ring is clearly visible against the wall or ceiling surrounding the fixture and it is either not aesthetically pleasing or does not blend well with the decor of the room. While some decorators may attempt to match the room decor or colors to blend with the lighting fixture, this is not a practical solution.

Kelmelis in U.S. Pat. No. 6,474,846, discloses a recessed lighting fixture with a specially designed trim ring. The trim ring may be covered with joint compound or spackle, thereby permitting the wall or ceiling finish and/or paint to be brought up to the rim of the recessed lighting. This invention effectively hides the trim ring and provide the appearance of a continuous surface surrounding the recessed lighting fixture. However, this process is not only time consuming, but joint compound or spackle applied to a plastic or metal tends to chip and this specially designed trim ring is not readily available and sold with traditional recessed lighting fixtures.

Thus, there is a need for an accent frame which can be used in conjunction with a typical recessed lighting trim (finishing) ring regularly sold with or for use with recessed lighting fixtures. The accent frame covers the joint between the fixture and the wall or ceiling to a greater extent than the finishing ring and also eliminates the problem associated with matching the colors or design of the trim ring with wall or ceiling colors or room decor.

Switch plates, electrical outlet plates, registers, grills, grates and the like, are similarly mounted in the ceiling, wall, or floor, and, thus, would benefit from such an accent frame that serves as both a decorative accent and a cover-up for any imperfections in the finish or cut of the surrounding ceiling, wall or floor.

### SUMMARY OF THE INVENTION

It is an object of the present invention to provide a decorative article or accent frame for a recessed lighting fixture, electrical box with switch plate or outlet plate, ducting system with register, grill, grate, or like article of a type inset in a wall, ceiling, or floor.

It is an object of the present invention that the accent frame gives an aesthetically pleasing appearance to the feature as well as to the surface area immediately surrounding it.

It is an additional object of the present invention that the accent frame serves to cover up any imperfections in the finish or cut of the surrounding ceiling, wall or floor, resulting from the installation process of the inset article.

It is an object of the present invention that the accent frame is easily installed by a homeowner in conjunction the article, such article being readily available on the market.

According to the stated objects, the present invention is an accent frame for an article of a type inset into a wall, ceiling or floor.

The accent frame consists of a rigid sheet of material adapted to fit against that portion of a wall or ceiling structure surrounding the article and accordingly has an inner edge defining an aperture corresponding to the wall, ceiling or floor cutout within which the article is inset.

The material of the accent frame may be flush against the wall, ceiling, or floor structure and sufficiently thin so that no perceptible dimension of thickness is apparent to an observer. Accordingly, the accent frame may be formed with a slight convex curvature to insure that it remains in contact with the surrounding wallboard when the inner edge is pressed against the wall, ceiling or floor by the finish ring flange, switch plate, grate, etc.

Alternatively, the material may flare slightly away from structure to provide an aesthetically pleasing depth or texture to the frame.

The accent frame may be colored in one or more matching or contrasting colors with an outer edge defining a patterned perimeter, such as a flower or star or the like. The color or colors of the accent frame may be selected to duplicate the coloration of the suggested object. Additionally, the accent frame design may incorporate the article itself to form a part of the suggested object.

In one embodiment of the present invention, the accent frame is adapted for use with a recessed lighting fixture of a type having a detachable finish ring or “trim ring”, including a radially extending flange. The finish ring flange is designed to fit flush with the surrounding wallboard and to cover the joint between the fixture and the wallboard. Installation of the accent frame is completed by removing the finish ring, placing the accent ring against the wall or ceiling with the lighting fixture centered within the frame aperture and replacing the finish ring. It is intended that the flange of the finish ring extends radially beyond the inner edge of the accent frame and presses the accent ring against the wallboard, thereby holding the accent ring in place.

In another embodiment, the accent frame is adapted for use with an inset electrical box or ducting system. The accent frame is placed against the wall, ceiling or floor, with the box or duct centered in the frame aperture. The appropriate switch plate, outlet plate, grate, grill, or register is then screwed into place, thereby, holding the accent frame in place.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a plan view of one embodiment of the present invention, namely a star-shaped accent frame for a recessed lighting fixture.

FIG. 2 is a perspective view of a flower-shaped accent frame for a recessed lighting fixture, showing the means of installation with the various components separated for illustration purposes.

FIG. 3a is a plan view of a house-shaped accent frame for electrical box with a switch plate or outlet plate.

FIGS. 3b and 3c are a front view and side view cross-section, respectively, of the accent frame of FIG. 3a installed.

### DETAILED DESCRIPTION OF THE PREFERRED EMBODIMENTS

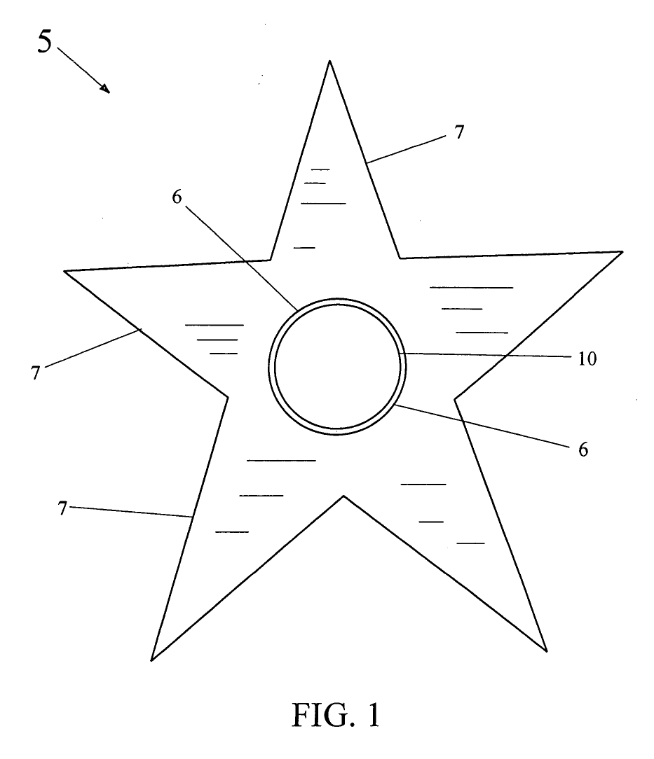

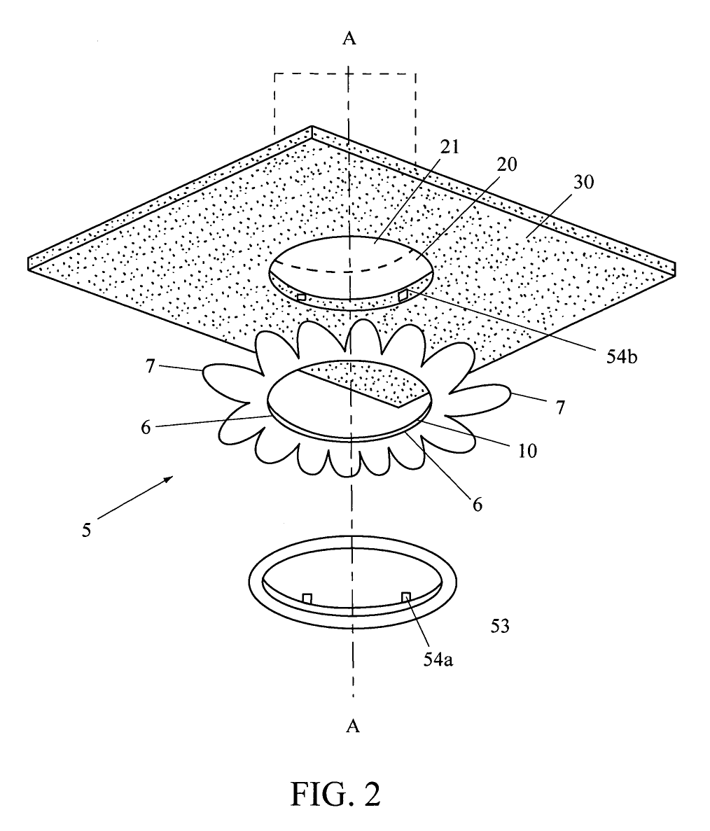

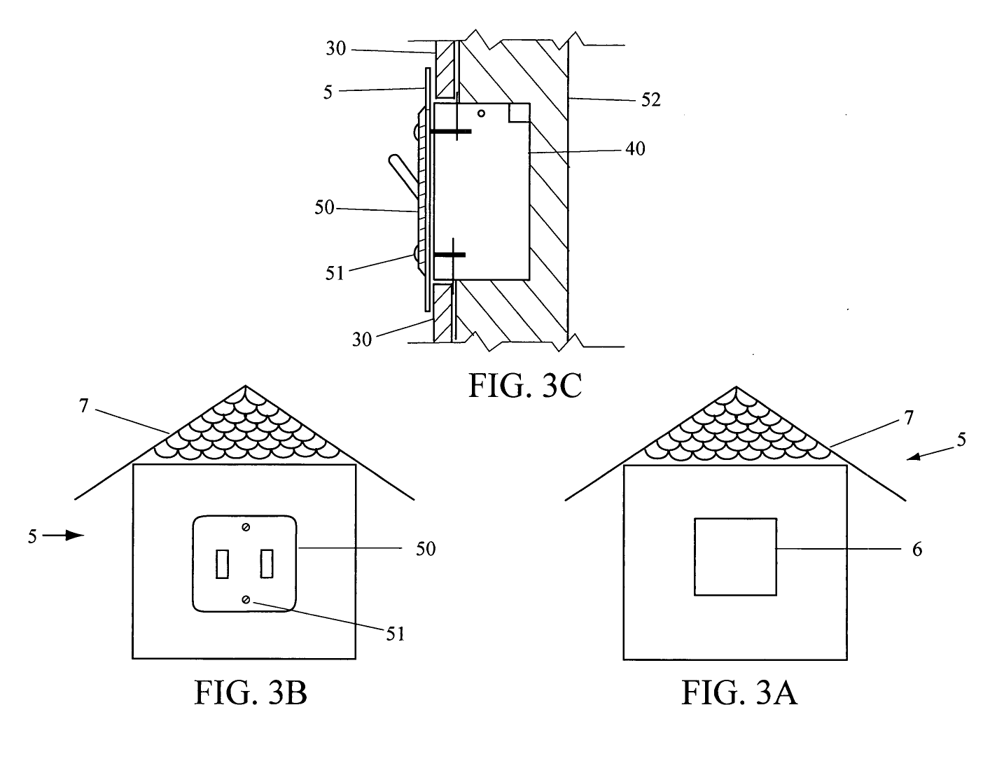

Referring in combination to FIGS. 1-3, the present invention is an accent frame 5 for a an inset article (i.e. recessed lighting fixture (See FIG. 2, Ref. #21), electrical box (See FIG. 3, Ref. #40), ducting system, etc.). The article is of a type inset within a cutout 20 of a structure 30 (i.e. wall, ceiling, or floor). The inset article is also of a type having a standard finishing ring (also called a trim ring) or covering plate to cover the joint between the inset article and the cutout and to generally cover up any imperfections in the cutout. For illustrations of such standard finishing rings or covering plate see the finishing ring of FIG. 2, Ref. #53 and switch plate of FIG. 3 Ref. #50. Other examples of a covering plate include an outlet plate, register, grill, grate, or like.

The accent frame 5 of the present invention surrounds the cutout and gives an aesthetically pleasing appearance to the article as well as to the surface area immediately surrounding it. In addition the accent frame 5 is larger than the trim ring or covering plate. Thus, the accent frame 5 serves as a decorative transition between the surrounding structure and the trim ring and also covers up any imperfections in the finish or cut of the surrounding ceiling, wall or floor, resulting from the installation process of the inset article, that are not covered by the standard trim ring or covering plate.

The accent frame 5 is comprised of a thin sheet of rigid material. The frame 5 is provided with an inner edge 6 defining an aperture. The frame aperture 6 corresponds, generally, in size and shape to the cut out 20 (See FIG. 2) to the wall, ceiling or floor structure (collectively ref. #30) for the inset article. A lip 10 may extend rearward from the aperture 6 into the cut out 20 to serve as a guide for proper positioning.

The accent frame 5 is further provided with an outer edge 7 defining a patterned perimeter. It is intended that the patterned perimeter be formed in a geometric shape or in a shape that suggests an object, for example a star (FIG. 1), a flower (FIG. 2), or a house (FIG. 3). The frame 5 may be colored (by painting or molded from pigmented material) with one or more colors which may be arranged to depict the object suggested by the shape of the patterned perimeter. The color or colors of the frame 5 may be selected to match or contrast with that of the structure 30.

The material of the accent frame 5 may be designed to sit flush against the wall, ceiling, or floor structure 30 and sufficiently thin so that no perceptible dimension of thickness is apparent to an observer. Accordingly, the accent frame 5 may be formed with a slight convex curvature to insure that it remains in contact with the surrounding wallboard when the inner edge is pressed against the wall, ceiling or floor by the finish ring flange, switch plate, grate, etc.

Alternatively, the material may flare slightly away from structure to provide an aesthetically pleasing depth or texture to the frame. For example, the frame 5 may flare out in the shape of a blooming flower (see FIG. 2).

In use, the accent frame 5 of the present invention is installed by a homeowner. Referring to FIGS. 2 and 3c, the frame is placed such that the frame aperture 6 is centered upon the cutout 20 in the wall, ceiling or floor 30, which was created for insetting the article (i.e. recessed lighting fixture, electrical box, ducting, etc). The lip 10 may assist with positioning of the frame 5. Referring to FIG. 2, a typical recessed lighting fixture 21 includes a standard finishing ring 53 that is attached to the recessed lighting fixture 21 by expandable tension clips/slots (54a/b). The standard finishing ring 53 is placed over the accent frame 5 and attached to the recessed lighting using the clips/slots (54a/b). The installed finishing ring 53 secures the frame 5 in place. Specifically, a portion of the accent frame 5 adjacent to the aperture 6 will be confined between the finishing ring 53 and the wall or ceiling 30, as illustrated by the dotted lines connecting the edge of the finishing ring 53 with the accent frame 5. The remaining portion of the accent frame 5 will be disposed about the area surrounding the recessed lighting fixture 21.

Referring to FIG. 3c, an inset electrical box 40 is mounted on a stud 52. The frame aperture 6 is centered upon the box 40. The frame 5 is sandwiched between the switch plate 50 and wall 30. The switch plate 50 is screw (51) attached to the box 40, securing the frame 5 in place. While the present embodiment is described herein with respect to an electrical box and switch plate, those skilled in the art will recognize that this embodiment is suitable for other inset articles, such as an electrical box and outlet plate or duct and grate/register, etc.

The frame 5 may be constructed of lightweight materials including metal, plastic, and wood, or a combination thereof, such that it is sufficiently rigid to maintain a horizontal or vertical orientation parallel to the cut out 20 and to remain in contact with the wall or ceiling 30 when installed. Additionally, the frame 5 may be cut to shape or formed by injection molding.

The frame 5 is preferably formed with a thickness of approximately 1 mm. This dimension is sufficiently thin so as not to be readily visible when viewed along a line parallel to the surface of the wall, ceiling or floor 30. More significantly, such a thin frame 5 will allow a finish ring or switch plate or the like to be installed without requiring alteration or added components. For example, referring to FIG. 3c, a 1 mm thin frame 5 can be easily installed between the switch plate 50 and wall 30 without requiring longer screws 51 for attachment to the electrical box 40. Similarly, referring to FIG. 2, a 1 mm thin frame 5 can be easily installed between the accent ring 53 provided by the manufacturer and the ceiling 30, without altering or purchasing a custom accent ring.

The present invention contemplates that the accent frames 5 could be formed in a wide variety of sizes and shapes to suit any decorating style. At a minimum, however, the frame 5 must be larger the standard finishing ring or covering plate. Those skilled in the art will recognize that a large size accent ring 5 may require an increase in the thickness over the recommended 1 mm thickness of the sheet material to support the frame in a horizontal orientation. Many variations of the accent frames 5 of the present invention may be constructed without departing from the scope of the invention as disclosed and claimed.

1. An accent frame for framing an article inset within a cutout of a structure, said inset article including a conventional trim ring or hub for providing a transition from said article to said structure; said accent frame comprising:
a rigid thin sheet of material larger in size than the finishing ring or covering plate and defined by an aperture corresponding in size and shape to said cutout, said frame being secured in place about the cutout and against the structure by the trim ring;
whereby said accent frame serves as an aesthetically pleasing backdrop to said finishing ring or hub and serves to cover up any imperfections in the finish or cut of the surrounding structure that may have resulted from.

2. The accent frame of claim 1, further comprising a decorative outer edge.

3. The accent frame of claim 1, wherein said accent frame is seated flush with said structure.

4. The accent frame of claim 1, wherein said frame flares slightly away from structure to provide an aesthetically pleasing depth or texture to the frame.

5. The accent frame of claim 2, wherein said decorative outer edge is object-shaped.

6. The accent frame of claim 1, wherein said thin sheet of material is approximately 1 mm thick.

7. The accent frame of claim 1, wherein said article is a recessed lighting fixture with a finishing ring attached to the recessed lighting fixture by expandable tension clips and slots and wherein said frame is secured in place between the structure and said attached finishing ring.

8. The accent frame of claim 1, wherein said article is an electrical box with a screw mounted outlet or switch plate and wherein said frame is secured in place between the structure and the outlet or switch plate.

9. The accent frame of claim 1, wherein said structure is a ceiling, wall or floor.

10. The accent frame of claim 1, wherein said frame is constructed of wood, metal or plastic materials.

11. The accent frame of claim 1, wherein said frame is formed by injection molding.

12. The accent frame of claim 1, wherein said frame is further comprised of a lip extending from the aperture 6 towards the cut out to serve as a guide for proper positioning.

13. The accent frame of claim 1, wherein said frame is both decorative and covers up any imperfections in the edges of the cut out not covered by the finishing ring or covering plate.
